(19) United States
(12) Patent Application Publication
(10) Pub. No.: US 2008/0245476 A1
(43) Pub. Date: Oct. 9, 2008

(54) Silane-Crosslinking Adhesive, Sealant or Coating With a Silicic Acid Filler and Use Thereof

(75) Inventors: Helmut Loth, Haan (DE); Oliver Schmidt, Langenfeld (DE); Jennifer Schmidt, Langenfeld (DE); Horst Beck, Neuss (DE); Markus Sumser, Herne (DE)

Correspondence Address: HENKEL CORPORATION, 1001 TROUT BROOK CROSSING, ROCKY HILL, CT, 06067, US

(73) Assignee: Henkel AG & Co. KGaA, Dusseldorf (DE)

(21) Appl. No.: 12/092,669

(22) PCT Filed: Nov. 9, 2006
(86) PCT No.: PCT/EP06/10738

§ 371 Date: May 5, 2008

(30) Foreign Application Priority Data
Nov. 10, 2005 (DE) 10 2005 054 008.2

(51) Int. Cl. B29C 65/48; C08K 3/36; C08K 7/00

(52) U.S. Cl. 156/329; 524/588; 524/493

(57) ABSTRACT

The present disclosure provides a silane crosslinking adhesive, sealant or coating containing a polymer, consisting of an organic framework that supports at least two alkoxy or acyloxysilyl groups and at least one filler. The filler consists at least partially of a highly disperse silicic acid with a BET surface area of 35 to 65 m²/g and is present in the adhesive, sealant or coating in a quantity of 1 to 60% by weight, in relation to the total weight of said adhesive, sealant or coating. The disclosure also provides the use of the adhesive, sealant or coating for bonding plastics, metal, glass, ceramics, wood or wood-based material, paper, paper-based material, rubber and textiles.

The present invention relates to a silane-crosslinking adhesive, sealant or coating material which comprises a polymer having an organic backbone that carries at least two alkoxy- or acyloxysilane groups, which are also referred to as alkoxy- or acyloxysilyl groups, and at least one filler.

Silane-crosslinking adhesives and sealants comprise alkoxysilyl-terminated polymers as binders. Polymer systems which possess reactive alkoxysilyl groups have been known for a long time. In the presence of atmospheric moisture, these alkoxysilyl-terminated polymers are capable even at room temperature of undergoing condensation with one another, in the course of which alkoxy groups are eliminated. Depending on the amount of alkoxysilyl groups and their construction, the principal products of the condensation are long-chain polymers (thermoplastics), relatively wide-meshed three-dimensional networks (elastomers) or else highly crosslinked systems (thermosets).

The polymers generally have an organic backbone that carries alkoxysilyl groups or alkoxysilane groups. The organic backbone may comprise, for example, polyurethanes, polyesters, polyethers, polyols, polyacrylates or -methacrylates, polyvinyl alcohols, etc.

Thus, for example, a one-component reactive system composition is known that comprises an alkoxysilyl-terminated polyurethane, a curing catalyst, and, if desired, typical additives.

It is an object of the present invention to specify silane-crosslinking adhesives, sealants or coating materials which have improved mechanical properties. More particularly, distinct improvements ought to be obtained in the initial strengths, tensile shear strengths, and adhesion.

Surprisingly it has been found that this object can be achieved through the use of highly disperse silica having a low BET surface area as a filler.

The present invention accordingly provides a silane-crosslinking adhesive, sealant or coating material of the type specified at the outset that is characterized in that the filler is composed at least partly of highly disperse silica having a BET surface area of 10 to 90 m²/g and is present in the material in an amount of 1% to 60% by weight, based on the total weight of the adhesive, sealant or coating material.

As well as improving the mechanical properties, the use of the highly disperse silica having the stated BET surface area in the adhesives, sealants or coating materials of the invention has further advantages.

The incorporation time of relatively high BET surface area silicas of the kind used in the prior art is comparatively long. Incorporation, accordingly, is cost-intensive. Furthermore, considerable quantities of air are introduced into the product, and must be removed again, which is complicated and laborious. Surprisingly it has been found that, when using the highly disperse silica having a BET surface area of 10 to 90 m²/g, the incorporation time is greatly reduced. Thus, for a BET surface area of 35 to 65 m²/g, the incorporation time is reduced by 30% to 50%. A further advantage is that the stated highly disperse silica can be incorporated into silane-terminated adhesives, sealants or coating materials in a considerably higher concentration without detriment to the transparency and the flow properties of the adhesives, sealants or coating materials.

The polymer present as binder in the adhesive, sealant or coating material of the invention conforms advantageously to the general formula (I)

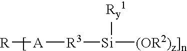

in which R is an organic backbone, A describes a carboxy, carbamate, carbonate, ureido, urethane or sulfonate bond, an oxygen atom or a methylene group, R¹ is an alkyl radical having 1 to 4 C atoms or OR², R² is an alkyl radical having 1 to 4 C atoms or an acyl radical having 1 to 4 C atoms, R³ is a linear or branched, substituted or unsubstituted alkylene radical having 1 to 8 C atoms, y is 0 to 2, z is 3−y, and n is 1 to 10 000, the silyl radicals being able to be alike or different and, where there are two or more radicals R¹ and/or R², they may in each case be alike or different.

The organic backbone is advantageously selected from the group encompassing alkyd resins, oil-modified alkyd resins, unsaturated polyesters, natural oils, e.g., linseed oil, tung oil, soybean oil, and also epoxides, polyamides, thermoplastic polyesters such as polyethylene terephthalate and polybutylene terephthalate, for example, polycarbonates, polyethylenes, polybutylenes, polystyrenes, polypropylenes, ethylene-proplene co- and terpolymers, acrylates, examples being homo- and copolymers of acrylic acid, acrylates, methacrylates, acrylamides, their salts, and the like, phenolic resins, polyoxymethylene homo- and copolymers, polyurethanes, polysulfones, polysulfide rubbers, nitrocellulose, vinyl butyrates, vinyl polymers, examples being polymers containing vinyl chloride and/or vinyl acetate, ethylcellulose, cellulose acetates and cellulose butyrates, rayon, shellac, waxes, ethylene copolymers such as ethylene-vinyl acetate copolymers, ethylene-acrylic acid copolymers, ethylene-acrylate copolymers, for example, organic rubbers, silicone resins, and the like. Further examples include polyethers such as polyethylene oxide, polypropylene oxide, and polytetrahydrofuran, polyol, polyacrylate, polymethacrylate, polyvinyl alcohol. Of the polymeric backbones stated, polyethers, polyesters, polyurethanes, and polyols are particularly preferred.

The fraction of the highly disperse silica having a BET surface area of 35 to 65 m²/g is advantageously 5% to 50% by weight, more particularly greater than 10% by weight, based on the total weight of the adhesive, sealant or coating material. Particularly preferred are amounts of 15% to 35% by weight, more particularly 20% to 25% by weight. The BET surface area of the highly disperse silica is preferably <90 m²/g, preferably 35 to 65 m²/g, more preferably 45 to 55 m²/g. Very particular preference is given to silica having a BET surface area of approximately 50 m²/g.

Besides this silica the adhesive, sealant or coating material may further comprise additional fillers of the kind used hitherto in the art. Suitable examples here include chalk, finely ground lime, precipitated and/or fumed silica, zeolites, bentonites, magnesium carbonate, kieselguhr, alumina, clay, tallow, titanium oxide, iron oxide, zinc oxide, quartz, flint, mica, and other ground minerals. In addition it is also possible to use organic fillers, more particularly carbon black, graphite, wood fibers, wood flour, wood shavings, cellulose, cotton, pulp, woodchips, chopped straw, chaff, ground walnut shells, and other short cut fibers. It is also possible, furthermore, to add short fibers such as glass fiber, glass filament, carbon fiber, Kevlar fiber or else polyethylene fibers. Aluminum powder is likewise a suitable filler.

Certain applications prefer fillers which endow the preparations with thixotropy, examples being hydrogenated castor oil, fatty acid amides or swellable plastics such as PVC. In order to be effectively extrudable from a suitable metering means (e.g., tube), such compositions possess a viscosity of 30 000 to 150 000, preferably of 40 000 to 80 000 mPas or else 50 000 to 60 000 mPas.

The silica for use in accordance with the invention advantageously has an average particle size d₅₀ as measured by laser diffraction of less than 25 μm, preferably of 5 to 25 μm.

As further ingredients the adhesive, sealant or coating material may comprise the conventional prior-art reactive diluents, plasticizers, solvents, UV stabilizers, antioxidants, catalysts, dryers, and adhesion promoters.

Thus, for example, it is possible that the viscosity of the composition of the invention is too high for certain applications. It has been found, however, that the viscosity of the adhesive, sealant or coating material of the invention can generally be reduced in a simple and judicious way, through the use of a “reactive diluent”, without substantial detriment to the physical properties of the cured composition.

The reactive diluent preferably contains at least one functional group which under the influence of moisture is capable of reacting with a reactive group of the adhesive, sealant or coating material, with chain extension and/or crosslinking (reactive diluent). The at least one functional group may be any functional group which reacts under the influence of moisture, with crosslinking or chain extension.

Suitable reactive diluents are therefore all polymeric compounds which are miscible with the adhesive, sealant or coating material, with a reduction in the viscosity, and which leave the physical properties of the product which forms after curing or crosslinking largely unaffected or at least not so adversely affected as to make the resulting product unusable. Suitability is possessed, for example, by polyesters, polyethers, addition polymers of compounds having olefinically unsaturated double bond, or polyurethanes, provided the abovementioned conditions are met.

Preferably, however, the reactive diluents are polyurethanes having at least one alkoxysilyl group as a reactive group.

The reactive diluents may contain one or more functional groups, though preferably the number of functional groups is 1 to about 6, more particularly about 2 to about 4, about 3 for example.

In one preferred embodiment the viscosity of the reactive diluents is less than about 20 000 mPas, more particularly about 1000 to about 10 000 mPas, about 3000 to about 6000 mPas for example (Brookfield RVT, 23° C., spindle 7, 2.5 rpm).

The reactive diluents which can be used in the context of the process of the invention may have any desired molecular weight distribution (PD) and, accordingly, are preparable by the typical methods of polymer chemistry.

As reactive diluents it is preferred to use polyurethanes which can be prepared from a polyol component and an isocyanate component with subsequent functionalization of one or more alkoxysilyl groups.

In the context of the present text the term “polyol component” embraces an individual polyol or a mixture of two or more polyols which can be used to prepare polyurethanes. A polyol is a polyfunctional alcohol, i.e., a compound having more than one OH group in the molecule.

As a polyol component for preparing the reactive diluents it is possible to use a multiplicity of polyols. These are, for example, aliphatic alcohols having two to 4 OH groups per molecule. The OH groups may be both primary and secondary. The suitable aliphatic alcohols include, for example, ethylene glycol, propylene glycol, and higher glycols, and also other polyfunctional alcohols.

Likewise suitable for use as a polyol component are polyethers which have been modified by vinyl polymers. Products of this kind are obtainable, for example, by polymerizing styrene and/or acrylonitrile in the presence of polyethers.

Likewise suitable as a polyol component for the preparation of the reactive diluent are polyester polyols having a molecular weight of about 200 to about 5000. Thus, for example, it is possible to use polyester polyols which come about through the reaction—already described above—of low molecular weight alcohols, more particularly of ethylene glycol, diethylene glycol, neopentyl glycol, hexanediol, butanediol, propylene glycol, glycerol or trimethylolpropane, with caprolactone. Likewise suitable as polyfunctional alcohols for preparing polyester polyols are, as already stated, 1,4-hydroxy-methylcyclohexane, 2-methyl-1,3-propanediol, butane-1,2,4-triol, triethylene glycol, tetraethylene glycol, polyethylene glycol, dipropylene glycol, polypropylene glycol, dibutylene glycol, and polybutylene glycol.

Further suitable polyester polyols can be prepared by polycondensation. Thus difunctional and/or trifunctional alcohols can be condensed with a substoichiometric amount of dicarboxylic acids and/or tricarboxylic acids or their reactive derivatives to form polyester polyols. Suitable dicarboxylic acids and tricarboxylic acids, and also suitable alcohols, have already been stated above.

Polyols used with particular preference in the context of the present invention as a polyol component for preparing the reactive diluents are, for example, dipropylene glycol and/or polypropylene glycol having a molecular weight of about 400 to about 2500 g/mol, and also polyester polyols, preferably polyester polyols obtainable by polycondensation of hexanediol, ethylene glycol, diethylene glycol or neopentyl glycol, or mixtures of two or more thereof, and isophthalic acid or adipic acid or mixtures thereof.

Likewise suitable as a polyol component for preparing the reactive diluents are polyacetals. Polyacetals are compounds of the kind obtainable from glycols, diethylene glycol or hexanediol, for example, with formaldehyde. Polyacetals which can be used in the context of the invention may likewise be obtained by the polymerization of cyclic acetals.

Of further suitability as a polyol for preparing reactive diluents are polycarbonates. Polycarbonates can be obtained, for example, through the reaction of diols such as propylene glycol, butene-1,4-diol or hexane-1,6-diol, diethylene glycol, triethylene glycol or tetraethylene glycol, or mixtures of two or more thereof, with diaryl carbonates, diphenyl carbonate for example, or carbonyl dichloride.

Likewise suitable as a polyol component for preparing the reactive diluents are polyacrylates which carry OH groups. These polyacrylates are obtainable, for example, through the polymerization of ethylenically unsaturated monomers which carry an OH group. Such monomers are obtainable, for example, through the esterification of ethylenically unsaturated carboxylic acids and difunctional alcohols, the alcohol generally being present in a slight excess. Examples of ethylenically unsaturated carboxylic acids suitable for this purpose include acrylic acid, methacrylic acid, crotonic acid or maleic acid. Corresponding esters carrying OH groups are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate, or mixtures of two or more thereof.

To prepare the reactive diluents that are preferred in accordance with the invention, the corresponding polyol component is reacted in each case with an at least difunctional isocyanate. A suitable at least difunctional isocyanate is in principle any isocyanate having at least two isocyanate groups; in the context of the present invention, however, preference is generally given to compounds having two to four isocyanate groups, more particularly having two isocyanate groups. Particularly suitable for preparing the reactive diluents are the polyisocyanates already stated above.

The compound that is present as a reactive diluent in the context of the present invention preferably contains at least one alkoxysilyl group, the preferred alkoxysilyl groups being the di- and trialkoxysilyl groups.

In addition to or instead of a reactive diluent, the viscosity of the polyurethanes of the invention can also be reduced using solvents and/or plasticizers.

Suitable solvents include aliphatic or aromatic hydrocarbons, halogenated hydrocarbons, alcohols, ketones, ethers, esters, ester alcohols, keto alcohols, keto ethers, keto esters, and ether esters. It is preferred, nevertheless, to use alcohols, since in that case there is an increase in the stability on storage. C₁-C₁₀ alcohols, particularly methanol, ethanol, isopropanol, isoamyl alcohol, and hexanol, are preferred.

The adhesive, sealant or coating material may further comprise hydrophilic plasticizers. These are used to improve the absorption of moisture and hence to improve the reactivity at low temperatures. Examples of suitable plasticizers include esters of abietic acid, adipic esters, azelaic esters, benzoic esters, butyric esters, acetic esters, esters of higher fatty acids having about 8 to about 44 C atoms, esters of fatty acids which are epoxidized or carry OH groups, fatty acid esters and fats, glycolic esters, phosphoric esters, phthalic esters, of linear or branched alcohols containing 1 to 12 C atoms, propionic esters, sebacic esters, sulfonic esters, thiobutyric esters, trimellitic esters, citric esters, and also nitrocellulose-based and polyvinyl acetate-based esters, and also mixtures of two or more thereof. Particularly suitable are the asymmetric esters of monooctyl adipate with 2-ethylhexanol (Edenol DOA, Cognis Deutschland GmbH, Düsseldorf).

Suitable for example are, from the phthalic esters, dioctyl phthalate, dibutyl phthalate or butyl benzyl phthalate; from the adipates, dioctyl adipate, diisodecyl adipate; diisodecyl succinate, dibutyl sebacate or butyl oleate.

Likewise suitable as plasticizers are the pure or mixed ethers of monofunctional, linear or branched C₄₋₁₆ alcohols or mixtures of two or more different ethers of such alcohols, an example being dioctyl ether (available as Cetiol OE, Cognis Deutschland GmbH, Düsseldorf).

A further preferred embodiment uses end group-capped polyethylene glycols as plasticizers. Examples are polyethylene or polypropylene glycol di-C₁₋₄ alkyl ethers, more particularly the dimethyl or diethyl ethers of diethylene glycol or dipropylene glycol, and also mixtures of two or more thereof.

Particularly preferred, however, are end group-capped polyethylene glycols, such as polyethylene or polypropylene glycol dialkyl ethers, the alkyl radical amounting to one to four C atoms, and more particularly the dimethyl and diethyl ethers of diethylene glycol and dipropylene glycol. With dimethyl-diethylene glycol more particularly, a cure which is acceptable even under adverse application conditions (low atmospheric humidity, low temperature) is achieved. For further details on plasticizers, refer to the relevant literature of industrial chemistry.

Likewise suitable as plasticizers in the context of the present invention are diurethanes, which can be prepared, for example, by reacting diols having OH end groups with monofunctional isocyanates, by choosing the stoichiometry such that substantially all of the free OH groups are consumed by reaction. Any excess isocyanate can be removed subsequently from the reaction mixture by distillation, for example. Another method of preparing diurethanes is to react monofunctional alcohols with diisocyanates, in which case very largely all of the NCO groups are consumed by reaction.

Examples of suitable catalysts for controlling the cure rate are organometallic compounds such as iron compounds or tin compounds, more particularly the 1,3-dicarbonyl compounds of iron or of divalent or tetravalent tin, more particularly the tin(II) carboxylates or the dialkyltin(IV) dicarboxylates or the corresponding dialkoxylates, examples being dibutyltin dilaurate, dibutyltin diacetate, dioctyltin diacetate, dibutyltin maleate, tin(II) octoate, tin(II) phenolate, or the acetylacetonates of divalent or tetravalent tin. It is also possible, furthermore, to use alkyl titanates, organosilicon titanium compounds or bismuth tris-2-ethylhexanoate, acidic compounds such as phosphoric acid, p-toluenesulfonic acid or phthalic acid, aliphatic amines such as butylamine, hexylamine, octylamine, decylamine or laurylamine, aliphatic diamines such as ethylenediamine, hexyldiamine or else aliphatic polyamines such as diethylenetriamine, triethylenetetramine, tetraethylenepentamine, for example, heterocyclic N compounds, e.g., piperidine, piperazine, aromatic amines such as m-phenylenediamine, ethanolamine, triethylamine, and other curing catalysts for epoxides.

Suitability is further possessed by the following compounds: ethyl silicate, dimethyl maleate, diethyl maleate, dioctyl maleate, dimethyl phthalate, diethyl phthalate, dioctyl phthalate, di(n-butyl)tin(IV) di(methyl maleate), di(n-butyl)tin(IV) di(butyl maleate), di(n-octyl)tin(IV) di(methyl maleate), di(n-octyl)tin(IV) di(butyl maleate), di(n-octyl)tin(IV) di(isooctyl maleate), di(n-butyl)tin(IV) sulfide, di(n-butyl)tin(IV) oxide, di(n-octyl)tin(IV) oxide, (n-butyl)₂Sn(SCH₂COO), (n-octyl)₂Sn(SCH₂COO), (n-octyl)₂Sn(SCH₂CH₂-COO), (n-octyl)₂Sn(SCH₂CH₂COOCH₂CH₂OCOCH₂S), (n-butyl)₂Sn-(SCH₂COO-i-C₈H₁₇)₂, (n-octyl)₂Sn(SCH₂COO-i-C₈H₁₇)₂, (n-octyl)₂Sn-(SCH₂COO-n-C₈H₁₇)₂.

Chelate-forming tin organyls can also be used, e.g., di(n-butyl)tin(IV) di(acetylacetonate), di(n-octyl)tin(IV) di(acetylacetonate), (n-octyl)(n-butyl)tin(IV) di(acetylacetonate).

The adhesive, sealant or coating material may further contain up to about 20% by weight of typical adhesion promoters (tackifiers). Suitable adhesion promoters are, for example, resins, terpene oligomers, coumarone/indene resins, aliphatic petrochemical resins, and modified phenolic resins. Suitability in the context of the present invention is possessed, for example, by hydrocarbon resins, of the kind obtained by polymerization of terpenes, principally α- or β-pinene, dipentene or limonene. These monomers are generally polymerized cationically with initiation using Fridel-Crafts catalysts. The terpene resins include also, for example, copolymers of terpenes and other monomers, examples being styrene, α-methylstyrene, isoprene, and the like. The stated resins find use, for example, as adhesion promoters for pressure-sensitive adhesives and coating materials. Likewise suitable are the terpene-phenolic resins, which are prepared by acid-catalyzed addition of phenols to terpenes or rosin. Terpene-phenolic resins are soluble in the majority of organic solvents and oils and are miscible with other resins, waxes, and rubber. Likewise suitable as an additive in the abovementioned sense in the context of the present invention are the rosins and their derivatives, such as their esters or alcohols, for example.

The adhesive, sealant or coating material may further contain up to about 7% by weight, more particularly up to about 5% by weight, of antioxidants.

The adhesive, sealant or coating material may also contain up to about 2% by weight, preferably about 1% by weight, of UV stabilizers. Particularly suitable UV stabilizers are those referred to as hindered amine light stabilizers (HALS). In the context of the present invention it is preferred to use a UV stabilizer which carries a silyl group and which in the course of crosslinking or curing is incorporated into the end product. Particularly suitable for this purpose are the products Lowilite 75 and Lowilite 77 (Great Lakes, USA). It is also possible, furthermore, to add benzotriazoles, benzophenones, benzoates, cyanoacrylates, acrylates, sterically hindered phenols, phosphorus and/or sulfur.

Frequently it is sensible to stabilize the adhesives, sealants or coating materials of the invention more effectively against moisture penetration, by means of dryers, in order to achieve a further increase in the shelflife.

An improvement in shelflife of this kind can be achieved, for example, through the use of dryers. Suitable dryers are all compounds which react with water to form a group which is inert toward the reactive groups present in the preparation, and which in so doing undergo extremely minor changes in their molecular weight. Furthermore, the reactivity of the dryers toward moisture that has penetrated the preparation must be higher than the reactivity of the end groups of the silyl-carrying polymer of the invention that is present in the composition.

### Examples of Suitable Dryers Are Isocyanates.

One preferred embodiment, however, uses silanes as dryers. These are, for example, vinylsilanes such as 3-vinylpropyltriethoxysilane, oximosilanes such as methyl-O,O′,O″-butan-2-one-trioximosilane or O,O′,O″,O′″-butan-2-one-tetraoximosilane (CAS Nos. 022984-54-9 and 034206-40-1) or benzamidosilanes such as bis(N-methylbenzamido)methyl-ethoxysilane (CAS No. 162230-35-6) or carbamatosilanes such as carbamato-methyltrimethoxysilane. Also possible, however, is the use of methyl-, ethyl- or vinyltrimethoxysilane, tetramethyl- or -ethylethoxysilane. Particular preference is given here, in terms of efficiency and costs, to vinyltrimethoxysilane and tetraethoxysilane.

Likewise suitable as dryers are the abovementioned reactive diluents, provided they have a molecular weight (Mₙ) of less than about 5000 g/mol and possess end groups whose reactivity toward penetrated moisture is at least as great, and preferably greater, than the reactivity of the reactive groups of the silyl-carrying polymer of the invention.

Finally as dryers it is also possible to use alkyl orthoformates or alkyl orthoacetates, e.g., methyl or ethyl orthoformate, methyl or ethyl orthoacetate.

The adhesives, sealants or coating materials of the invention generally contain about 0% to about 6% by weight of dryers.

The adhesive, sealant or coating material of the invention is prepared by known methods, by intimate mixing of the ingredients in suitable dispersing assemblies, such as a high-speed mixer, for example.

The invention also relates to the use of the adhesive, sealant or coating material to bond plastics, metals, glass, ceramic, wood, woodbase materials, paper, paper materials, rubber, and textiles, to bond floors, to seal parts of buildings, windows, wall and floor coverings, and joints in general. In these contexts the materials may in each case be bonded to themselves or to any other of the materials. The invention is illustrated below with reference to working examples.

Raw materials

| Raw material | | |
|---|---|---|
| number | Trade name | General raw material designation |
| 1 | — | silane-terminated organic polymer |
| 2 | Aerosil R 8200 | aftertreated fumed silica |
| 3 | Geniosil GF 96 | 3-aminopropyltrimethoxysilane |
| 4 | Vinylsilan XL 10 | vinyltrimethoxysilane |
| 5 | Katalysator DBU | 1,8-diazabicyclo[5.4.0]undec-7-ene |
| 6 | Durasil H | microsilica |
| 7 | Aerosil OX 50 | microsilica |

### Preparation Instructions For Raw Material 1

155.1 g (19 mmol) of polypropylene glycol 8000 (M=8000 g/mol, OHN=14.0) were dried under reduced pressure at 100° C. in a 500 ml three-necked flask. Under a nitrogen atmosphere, at 80° C., 0.06 g of dibutyltin laurate was added and then 15.3 g (87 mmol) of TDI (% NCO=47.8) were added. After an hour of stirring at 80° C. the resulting polymer was admixed with 103.4 g (105 mmol) of polyTHF 1000 (M=1000 g/mol, OHN=114) and stirred at 80° C. for a further hour. A mixture of 10.2 g (45 mmol) of isocyanato-propyltrimethoxysilane (% NCO=18.3) and 5.5 g (34 mmol) of isocyanato-methyldimethoxymethylsilane (% NCO=25.7) was added and the mixture was stirred at 80° C. for a further hour. The polymer was cooled and admixed with 6 g of vinyltrimethoxysilane. The product was stored in a glass vessel with a moistureproof seal under a nitrogen atmosphere.

### Preparation Instructions For Silane-Terminated Adhesives

The preparation takes place in a Speedmixer, e.g., SpeedMixer DAC 400 FVZ from Hauschild Engineering.

### Preparation of Example 1:

1. Weigh out raw material 1
2. Weigh out raw material 4
3. Mix with Speedmixer at 2000 rpm, 30 seconds
4. Weigh out raw material 6; 1/3 of the respective total raw material concentration
5. Apply vacuum
6. Mix with Speedmixer at 2000 rpm, 30 seconds
7. Weigh out raw material 6; ⅓ of the respective total raw material concentration
8. Apply vacuum
9. Mix with Speedmixer at 2000 rpm, 30 seconds
10. Weigh out raw material 6; ⅓ of the respective total raw material concentration
11. Apply vacuum
12. Mix with Speedmixer at 2000 rpm, 30 seconds
13. Weigh out raw material 3
14. Mix with Speedmixer at 2000 rpm, 30 seconds
15. Weigh out raw material 5
16. Mix with Speedmixer at 2000 rpm, 30 seconds

### Preparation of Example 2:

1. Weigh out raw material 1
2. Weigh out raw material 4
3. Mix with Speedmixer at 2000 rpm, 30 seconds
4. Weigh out raw material 7; ⅓ of the respective total raw material concentration
5. Apply vacuum
6. Mix with Speedmixer at 2000 rpm, 30 seconds
7. Weigh out raw material 7; ⅓ of the respective total raw material concentration
8. Apply vacuum
9. Mix with Speedmixer at 2000 rpm, 30 seconds
10. Weigh out raw material 7; ⅓ of the respective total raw material concentration
11. Apply vacuum
12. Mix with Speedmixer at 2000 rpm, 30 seconds
13 Weigh out raw material 3
14. Mix with Speedmixer at 2000 rpm, 30 seconds
15. Weigh out raw material 5
16. Mix with Speedmixer at 2000 rpm, 30 seconds

### Preparation of Comparatives 3 and 4:

1. Weigh out raw material 1
2. Mix with Speedmixer at 2000 rpm, 30 seconds
3. Weigh out raw material 4
4. Mix with Speedmixer at 2000 rpm, 30 seconds
5. Weigh out raw material 2; ⅓ of the respective total raw material concentration
6. Apply vacuum
7. Mix with Speedmixer at 2000 rpm, 30 seconds
8. Weigh out raw material 2; ⅓ of the respective total raw material concentration
9. Apply vacuum
10. Mix with Speedmixer at 2000 rpm, 30 seconds
11. Weigh out raw material 2; ⅓ of the respective total raw material concentration
12. Apply vacuum
13. Mix with Speedmixer at 2000 rpm, 30 seconds
14. Weigh out raw material 3
15. Mix with Speedmixer at 2000 rpm, 30 seconds
16. Weigh out raw material 5
17. Mix with Speedmixer at 2000 rpm, 30 seconds

### Adhesive Formulas

### Testing of Tensile Shear Strengths:

Test specimens of a wide variety of materials are bonded in triplicate to a wooden test specimen, made for example of three-ply beech plywood, and the bonds are stored for 7 days. The bond area measures 2.5 cm×2.0 cm.

The bonds are made unilaterally. Using a toothed applicator, excess adhesive is removed. After 7 days the tensile shear strength is ascertained using a materials testing instrument from Zwick, e.g., instrument type Zwick Z010.

### Testing of Initial Strengths:

Two wooden test specimens, e.g., three-ply beech plywood, are bonded to one another. The bond area measures 2.5 cm×2.0 cm. The bonds are made unilaterally. Using a toothed applicator, excess adhesive is removed.

The bond area is aired for 2 minutes; the time is measured using a digital laboratory stopwatch. Thereafter the two test specimens are bonded by the application and pressing, for 5 seconds, of a 5 kg weight.

The tensile shear strength is tested immediately thereafter and after 5 minutes, 15 minutes, 30 minutes, and 60 minutes.

The tensile shear strength corresponds to the respective strength. The determination is carried out in duplicate.

### EXAMPLE 1

TABLE 1
Formulas:

| | | Ex. 1 | Ex. 2 | Comp. 3 | Comp. 4 | Comp. 5 | Comp. 6 |
|---|---|---|---|---|---|---|---|
| Raw material 1 | % by wt. | 70.0 | 70.0 | 79.87 | 79.02 | 79.27 | 70.0 |
| Aerosil R 8200 | % by wt. | 0 | 0 | 7.98 | 7.98 | 7.98 | 17.25 |
| Durasil H | % by wt. | 17.25 | 0 | 0 | 0 | 0 | 0 |
| Aerosil OX 50 | % by wt. | 0 | 17.25 | 0 | 0 | 0 | 0 |
| AMMO/GF96 | % by wt. | 6.0 | 6.0 | 6.0 | 6.0 | 6.0 | 6.0 |
| Vinylsilan XL 10 | % by wt. | 6.0 | 6.0 | 6.0 | 6.0 | 6.0 | 6.0 |
| DBU | % by wt. | 0.75 | 0.75 | 0.15 | 1.00 | 0.75 | 0.75 |
| Total | % by wt. | 100.00 | 100.00 | 100.00 | 100.00 | 100.00 | 100.00 |

Comparative 6: very high viscosity; cannot be processed.

TABLE 2
Tensile shear strengths

| Values in | | | Com- | Com- | Com- |
|---|---|---|---|---|---|
| N/mm² | Example 1 | Example 2 | parative 3 | parative 4 | parative 5 |
| ABS | 4.4 | 4.1 | 2.2 | 2.0 | 1.7 |
| PS | 4.1 | 3.1 | 2.6 | 2.3 | 2.1 |
| PMMA | 6.2 | 2.4 | 2.9 | 2.0 | 2.4 |
| Aluminum | 7.4 | 6.0 | 4.5 | 7.1 | 6.6 |
| Copper | 8.4 | 6.9 | 5.3 | 6.0 | 6.5 |
| Brass | 8.7 | 6.7 | 7.8 | 6.3 | 7.0 |
| PVC | 7.7 | 5.5 | 6.6 | 6.7 | 5.7 |
| Beech | 8.8 | 6.0 | 7.1 | 6.9 | 6.9 |

TABLE 3
Initial strength [N/cm²]
Inserted after 2 minutes

| Ruptured | | | | | |
|---|---|---|---|---|---|
| after | | | Com- | Com- | Com- |
| [min.] | Example 1 | Example 2 | parative 3 | parative 4 | parative 5 |
| 0 | 5 | 6 | 1 | 2 | 2 |
| 5 | 39 | 27 | 7 | 15 | 20 |
| 15 | 180 | 69 | 40 | 69 | 91 |
| 30 | 240 | 170 | 113 | 227 | 306 |
| 60 | 342 | 174 | 185 | 374 | 495 |

TABLE 4
Technical data
Product information, highly disperse silicas

| | SiO₂ | | BET surface | Specific | Oil | |
|---|---|---|---|---|---|---|
| | content | | area | weight | number | |
| | % | pH* | m²/g | g/mm | ml/100 g | d50 μm |
| Dura- | >99.0 | 3.0-4.0 | 51 +/− 2 | 2.2-2.3 | 83 | 10 |
| Sil H | | | | | | |
| Aerosil | 99.8 | 5.0 | 160 +/− 25 | 2.2-2.3 | 200 | — |
| R 8200 | | | | | | |
| Aerosil | >99.8 | 3.8-4.8 | 50 +/− 15 | 2.2-2.3 | 89 | — |
| OX 50 | | | | | | |

*4% dispersion

1. A silane-crosslinking adhesive, sealant or coating material comprising a polymer composed of an organic backbone that carries at least two alkoxy- or acyloxysilyl groups and of at least one filler, wherein the filler is composed at least partly of highly disperse silica having a BET surface area of 10 to 90 m²/g and is present in the material in an amount of 1% to 60% by weight, based on the total weight of the adhesive, sealant or coating material.

2. The adhesive, sealant or coating material of claim 1, wherein the highly disperse silica has a BET surface area of 35 to 65 m²/g.

3. The adhesive, sealant or coating material of claim 1, wherein the polymer conforms to the general formula (I) 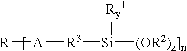
in which R is an organic backbone,
A is a carboxy, carbamate, carbonate, ureido, urethane or sulfonate bond, an oxygen atom or a methylene group,
R¹ is an alkyl radical having 1 to 4 C atoms or OR²,
R² is an alkyl radical having 1 to 4 C atoms or an acyl radical having 1 to 4 C atoms,
R³ is a linear or branched, substituted or unsubstituted alkylene radical having 1 to 8 C atoms,
y is 0 to 2,
z is 3−y, and
n is 1 to 10 000,
the silyl radicals being alike or different and R¹ and R² being alike or different.

4. The adhesive, sealant or coating material of claim 1, wherein the organic backbone is selected from the group encompassing alkyd resins, oil-modified alkyd resins, unsaturated polyesters, natural oils, epoxides, polyamides, thermoplastic polyesters, polycarbonates, polyethylenes, polybutylenes, polystyrenes, polypropylenes, ethylene-propylene co- and terpolymers, acrylates, phenolic resins, polyoxymethylene homo- and copolymers, polyurethanes, polysulfones, polysulfide rubbers, nitrocellulose, vinyl butyrates, vinyl polymers, ethylcellulose, cellulose acetates and cellulose butyrates, rayon, shellac, waxes, ethylene copolymers, ethylene-acrylic acid copolymers, ethylene-acrylate copolymers, organic rubbers, silicone resins, and the backbone may also contain silyl groups.

5. The adhesive, sealant or coating material of claim 1, wherein the polymeric backbone is a polyether, polyester, polyurethane or polyol.

6. The adhesive, sealant or coating material of claim 1, wherein the fraction of the highly disperse silica is 15% to 35% by weight, based on the total weight of the adhesive, sealant or coating material.

7. The adhesive, sealant or coating material of claim 1, wherein the silica has an average particle size d₅₀ as measured by laser diffraction of less than 25 μm.

8. A method of bonding plastics, metals, glass, ceramic, wood, woodbase materials, paper, paper materials, rubber, and textiles comprising utilizing the adhesive, sealant or coating material of claim 1.

9. The adhesive, sealant or coating material of claim 1 wherein the silica has an average particle size d₅₀ as measured by laser diffraction of 5 to 25 μm.

10. A silane-crosslinking adhesive, sealant or coating material comprising:
a polymer comprising general formula (I) 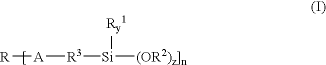
in which R is polyether, polyester, polyurethane or polyol,
A is a carboxy, carbamate, carbonate, ureido, urethane or sulfonate bond, an oxygen atom or a methylene group,
R¹ is an alkyl radical having 1 to 4 C atoms or OR²,
R² is an alkyl radical having 1 to 4 C atoms or an acyl radical having 1 to 4 C atoms,
R³ is a linear or branched, substituted or unsubstituted alkylene radical having 1 to 8 C atoms,
y is 0 to 2,
z is 3−y,
n is 1 to 10 000,
the silyl radicals can be alike or different and R¹ and R² can be alike or different; and
10% to 35% by weight, based on the total weight of the adhesive, sealant or coating material of a highly disperse silica filler having a BET surface area of 35 to 65 m²/g and an average particle size d₅₀ as measured by laser diffraction of 5 to 25 μm.
